(19) United States
(12) Patent Application Publication
(10) Pub. No.: US 2014/0219839 A1
(43) Pub. Date: Aug. 7, 2014

(54) POWER SUPPLY DEVICE OF ROTARY COMPRESSOR

(71) Applicant: RECHI PRECISION CO., LTD, Taoyuan Hsien (TW)

(72) Inventors: Wen-Jen Kuo, Taoyuan Hsien (TW); Yi-Liang Liao, Taoyuan Hsien (TW)

(73) Assignee: RECHI PRECISION CO., LTD, Taoyuan Hsien (TW)

(21) Appl. No.: 14/052,809

(22) Filed: Oct. 14, 2013

(30) Foreign Application Priority Data
Feb. 7, 2013 (CN) 201320071408.9

(51) Int. Cl. H02K 5/22; F04C 23/02

(52) U.S. Cl. CPC H02K 5/225; F04C 23/02
USPC 417/410.3; 310/71

(57) ABSTRACT

Disclosed is a power supply device of a rotary compressor, and an electrical connector is installed at a casing of the rotary compressor for electrically connecting a motor installed inside the casing and an external power supply. A planar portion is disposed on a lateral side of the casing for installing the electrical connector, so that the electrical connector installed on a lateral side of the casing of the rotary compressor casing will not cause an increase of height of the rotary compressor to achieve a convenient installation. In addition, a protective cover is mounted onto the planar portion for covering the electrical connector, and the bottom of the protective cover is attached onto the planar portion. The electrical connector is protected by the protective cover without being exposed.

### FIELD OF THE INVENTION

The present invention relates to a power supply device, and more particularly to the power supply device applied in a rotary compressor, and the height of the rotary compressor can be reduced to facilitate the installation of an electrical connector.

### BACKGROUND OF THE INVENTION

Compressor is generally used in electrical products such as refrigerators, air-conditioners/heaters, dryers, heat pump water heaters, dehumidifiers. The compressor mainly includes a motor driven by electric power, an electrical connector installed on a compressor casing for supplying the electric power to the motor to operate the motor, so as to drive the motor to operate and produce the compression effect of inputted/outputted air.

However, the electrical connector is generally in form of a terminal structure, and the conventional electrical connector is disposed above the rotary compressor and exposed from the casing. As a result, the height of the casing is increased, and the installation becomes more inconvenient.

### SUMMARY OF THE INVENTION

In view of the aforementioned shortcomings of the prior art, it is a primary objective of the present invention to overcome the shortcomings by providing a power supply device of an electrical connector, and the power supply device is applied in a rotary compressor to facilitate the installation.

To achieve the aforementioned objective, the present invention provides a power supply device of a rotary compressor, wherein an electrical connector is installed at a casing of the rotary compressor for electrically connecting a motor installed in the casing and an external power supply, and the casing has a planar portion disposed on a lateral side of the casing for installing the electrical connector.

The electrical connector of the present invention is installed on a lateral side of the casing of the rotary compressor, and thus will not cause an increase of height of the rotary compressor to facilitate the installation. In addition, the planar portion formed on the lateral side can improve the convenience of installing the electrical connector.

The present invention further provides a power supply device of a rotary compressor, wherein an electrical connector is installed at a casing of the rotary compressor for electrically connecting a motor installed inside the casing and an external power supply, and the casing has a planar portion disposed on a lateral side of the casing for installing the electrical connector, and the electrical connector has at least three terminals and is further connected to a connector.

The present invention further provides a power supply device of a rotary compressor, wherein an electrical connector is installed at a casing of the rotary compressor for electrically connecting a motor installed inside the casing and an external power supply, and the casing has a planar portion disposed on a lateral side of the casing for installing the electrical connector, and the electrical connector has at least three terminals and is further connected to a connector, and a protector is coupled to the other end of the connecting element and installed on a lateral side of the casing and relative to the planar portion at the top of the electrical connector.

### BRIEF DESCRIPTION OF THE DRAWINGS

FIG. 1 is a schematic view of a rotary compressor of the present invention;

FIG. 2 is a cross-sectional view of a rotary compressor of the present invention;

FIG. 3 is a perspective view of a power supply device in accordance with a first preferred embodiment of the present invention;

FIG. 4 is a perspective view of a power supply device in accordance with a second preferred embodiment of the present invention;

FIG. 5 is a blow-up view of a power supply device in accordance with the second preferred embodiment of the present invention;

FIG. 6 is a perspective view of a power supply device in accordance with a third preferred embodiment of the present invention;

FIG. 7 is a blow-up view of a power supply device in accordance with the third preferred embodiment of the present invention; and

FIG. 8 is a perspective view of a power supply device in accordance with a fourth preferred embodiment of the present invention.

### DESCRIPTION OF THE PREFERRED EMBODIMENTS

The technical characteristics of the present invention will become clearer in light of the following detailed description of illustrative embodiments of this invention. It is intended that the embodiments disclosed herein are to be considered illustrative rather than restrictive.

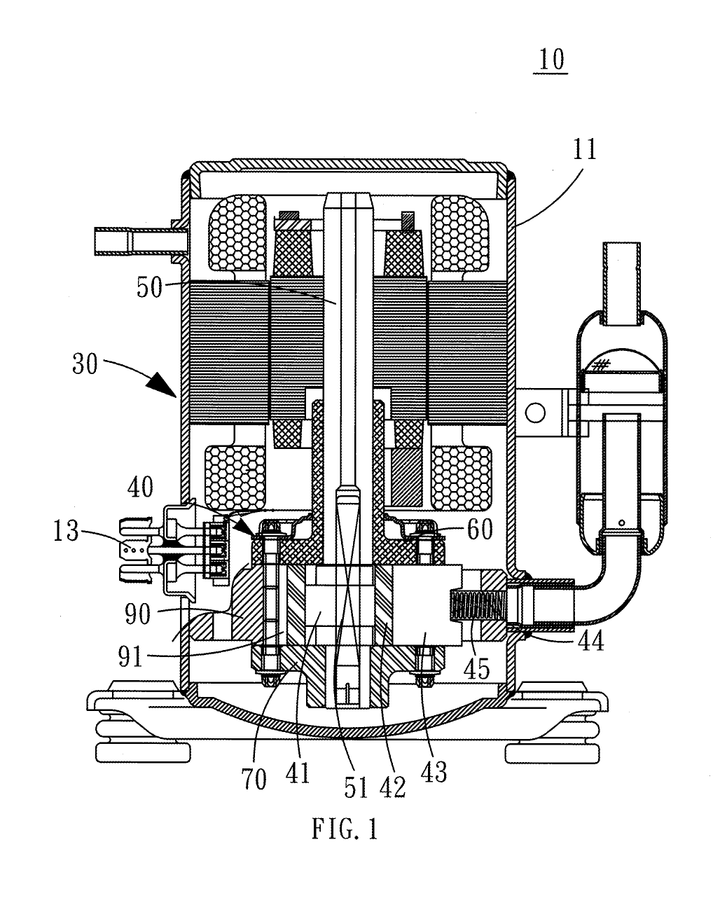

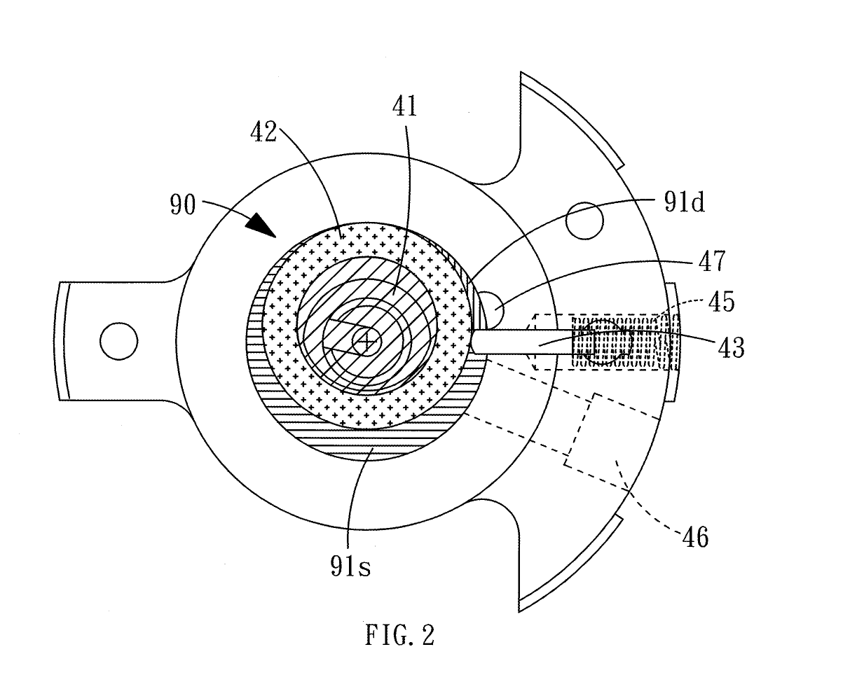

With reference to FIGS. 1 and 2 for the a schematic view and a cross-sectional view of a rotary compressor of the present invention respectively, the rotary compressor 10 comprising a casing 11, a motor 30 and a rotary compression element 40 installed inside the casing 11, wherein an electrical connector 13 is installed at the casing 11 for electrically connecting the motor 30 installed inside the casing 11 and an external power supply. The rotary compression element 40 drives a rotary shaft 50 to extend from the motor 30 through an upper holder 60 and a lower holder 70, and a cylinder 90 is installed between the upper holder 60 and the lower holder 70, and a spiral plate 51 is installed at the internal diameter of the rotary shaft 50; a cam 41 is installed in a cylinder chamber 91 of the cylinder 90 and biased from the rotary shaft 50, and a ring portion 42 is sheathed on the cam 41. On the other hand, the cylinder 9 as shown in FIG. 2 includes a vane 43 pushed by a spring 45 received in a spring storage space 44 towards the cam 41 and corresponding to the rotation of the cam 41, and the vane 43 can be moved reciprocally to play the role of partitioning the interior of the cylinder chamber 91 into a low pressure chamber 91s and a high pressure chamber 91d. The spiral plate 51 carries refrigerant oil at the bottom layer of the compressor to the external diameter of the shaft by the principle of the centrifugal force by the rotation of the rotary shaft 50.

The compressor 10 uses the motor 30 to rotate the cam 41 eccentrically in the cylinder chamber 91, such that the gas passing through suction port 46 and being sucked into the low pressure chamber 91s of the cylinder chamber 91 will move in a direction towards the high pressure chamber 91d while compressing the gas to exit from a discharge port 47, so as to achieve the rotary compression effect.

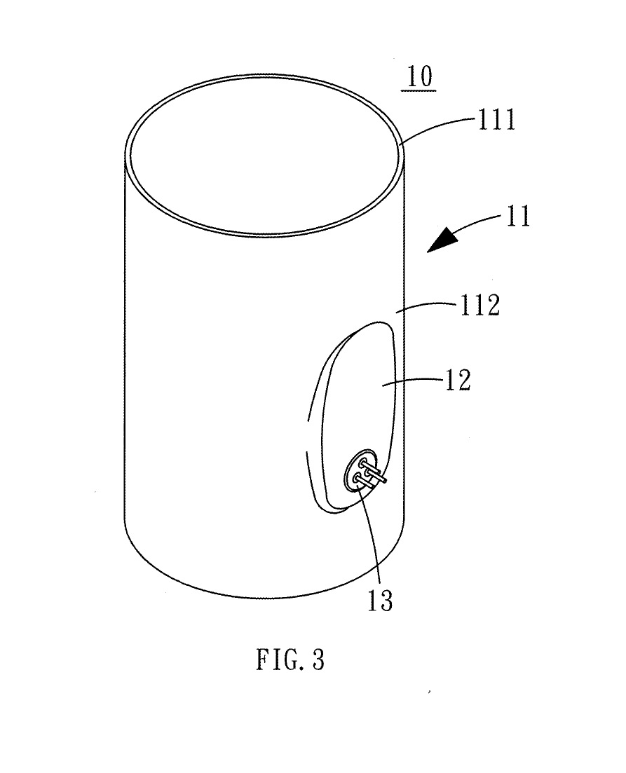

In FIG. 3, the present invention is characterized in that the casing 11 has a top side 111 and a lateral side 112 around the top side, wherein a planar portion 12 is disposed on the lateral side 112 of the casing 11 for installing the electrical connector 13. The electrical connector 13 of the present invention is installed on the lateral side 112 of the casing 11 of the rotary compressor 10, and thus will not cause an increase of height of the rotary compressor 10 to facilitate the installation. In addition, the planar portion 12 formed on the lateral side 112 can improve the installation of the electrical connector 13 significantly.

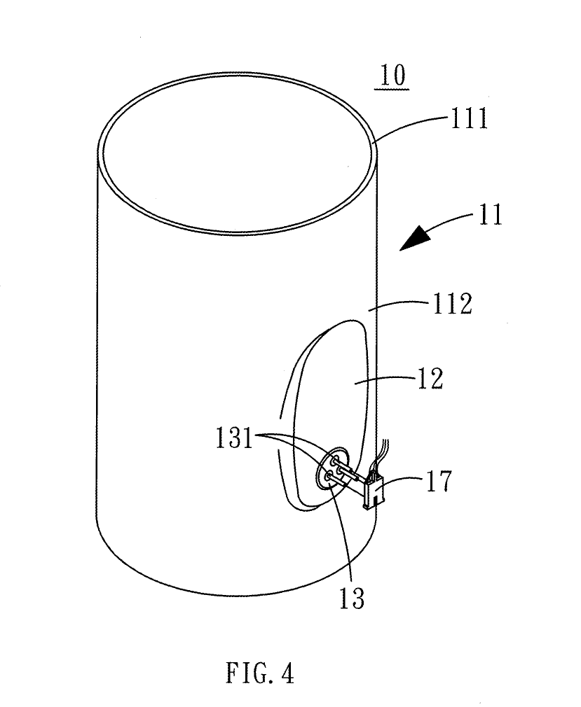

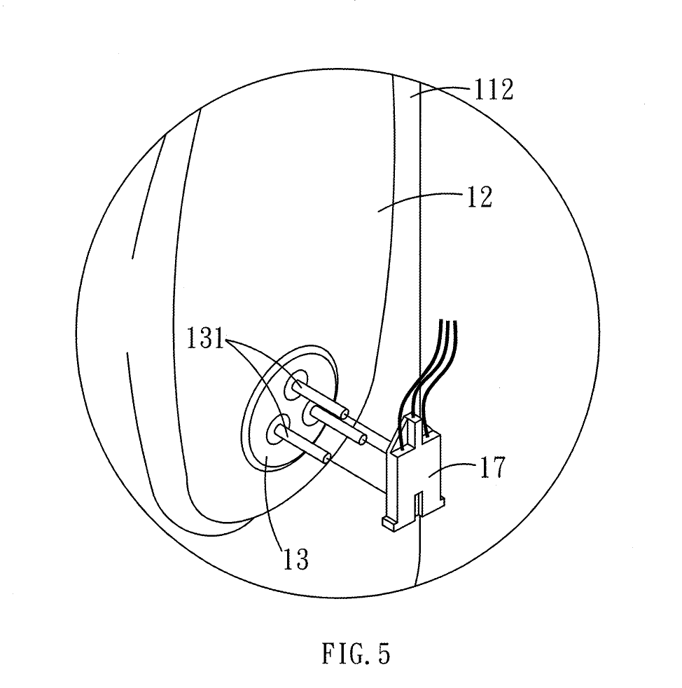

With reference to FIGS. 4 and 5 for a perspective view and a blow-up view of a power supply device in accordance with the second preferred embodiment of the present invention respectively, the electrical connector 13 disposed on the lateral side 112 of the casing 11 has at least three terminals 131, and the terminal 131 is a cylindrical structure as shown in the figures, and the terminal 131 is further connected to a connector 17 for transmitting power or signal, wherein the connector 17 can be a standalone device, and each terminal 131 is plugged into the connector 17 to achieve an electrical connection effect.

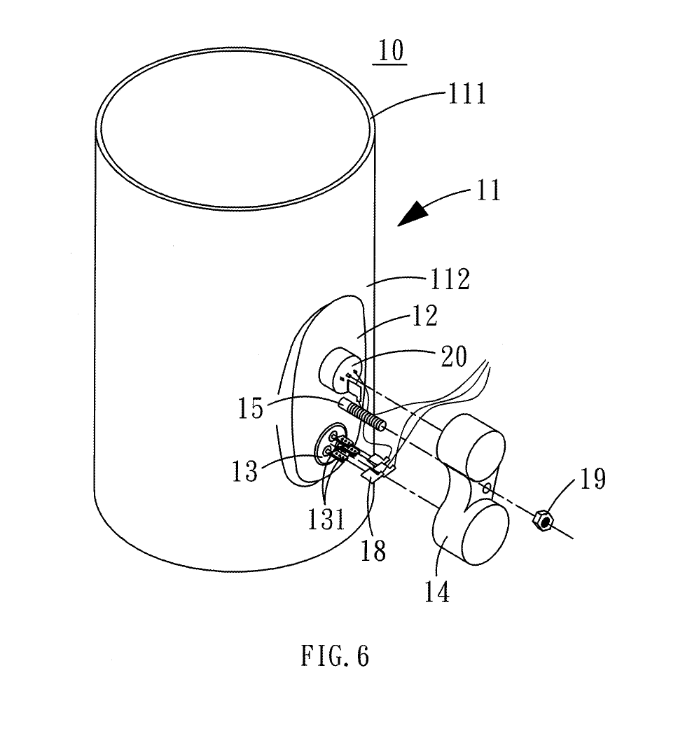

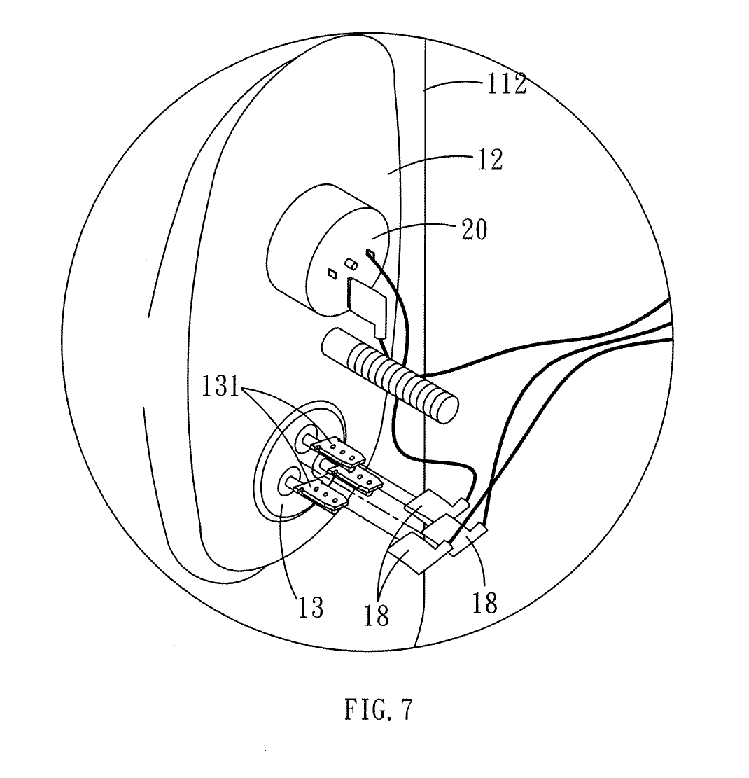

With reference to FIGS. 6 and 7 for a perspective view and a blow-up view of a power supply device in accordance with the third preferred embodiment of the present invention respectively, the electrical connector 13 disposed on the lateral side 112 of the casing 11 has at least three terminals 131, and each terminal 131 is a flat structure as shown in the figures, and each terminal 131 is connected to a corresponding connecting element 18 to transmit power or signal independently, and each terminal 131 is sheathed and connected to the connecting element 18 to achieve an electrical connection effect.

In addition, the other end of the connecting element 18 is further connected to a protector 20, and the protector 20 can be mounted onto the lateral side 112 of the casing 11 and relative to the planar portion 12 at the top of the electrical connector, and a protective cover 14 is also covered onto the electrical connector 13 and the protector 20, and the protective cover 14 is installed onto the planar portion 12 for covering the electrical connector 13 and the protector 20, and the bottom 141 of the protective cover 14 is attached onto the planar portion 12.

In the installation, a fixing element which is a screw rod 15 installed on the planar portion 12, and the fixing element can be soldered directly onto the planar portion 12, and the protective cover 14 has a through hole 142 relative to the screw rod 15 for sheathing on the screw rod 15, and a screw element 19 (which can be a nut) is fixed to the screw rod 15 through the protective cover 14 in order to fix the protective cover 14 to the screw rod 15.

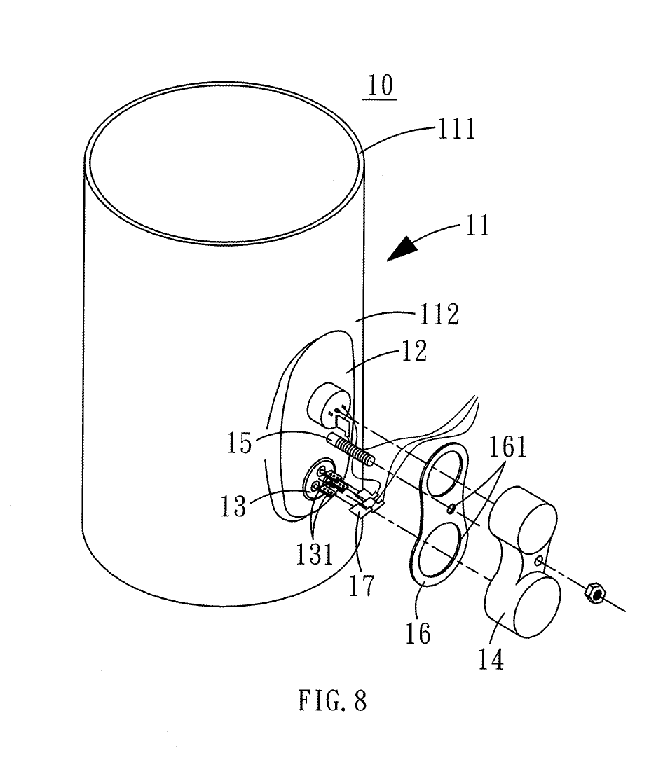

In the fourth preferred embodiment as shown in FIG. 8, a gasket 16 is installed between the planar portion 12 and the protective cover 14, and the gasket 16 has an opening 161 relative to the screw rod 15, and the gasket 16 has an opening 161 relative to the electrical connector 13 and provided for exposing the electrical connector 13. In the installation, the gasket 16 is passed and installed at the bottom of the screw rod 15, and then the protective cover 14 is mounted onto the screw rod 15 and relative to the gasket 16, and the function of the gasket 16 can improve the airtight effect between the planar portion 12 and the protective cover 14.

What is claimed is:

1. A power supply device of a rotary compressor, comprising an electrical connector installed at a casing of the rotary compressor for electrically coupling a motor installed inside the casing and an external power supply, characterized in that the casing has a planar portion disposed on a lateral side of the casing for installing the electrical connector.

2. The power supply device of a rotary compressor according to claim 1, wherein the planar portion has a protective cover mounted thereon for covering the electrical connector, and the bottom of the protective cover is attached onto the planar portion.

3. The power supply device of a rotary compressor according to claim 2, wherein the planar portion has a fixing element installed thereon for fixing the protective cover.

4. The power supply device of a rotary compressor according to claim 3, wherein the fixing element is a screw rod for fixing the protective cover, and the protective cover has a through hole relative to the screw rod.

5. The power supply device of a rotary compressor according to claim 4, further comprising a gasket installed between the planar portion and the protective cover, and the gasket has an opening relative to the screw rod.

6. The power supply device of a rotary compressor according to claim 5, wherein the gasket has an opening relative to the electrical connector for exposing the electrical connector.

7. A power supply device of a rotary compressor comprising an electrical connector installed at a casing of the rotary compressor for electrically coupling a motor installed inside the casing and an external power supply, characterized in that the casing has a planar portion disposed on a lateral side of the casing for installing the electrical connector, and the electrical connector has at least three terminals, and is further connected to a connector.

8. The power supply device of a rotary compressor according to claim 7, wherein the planar portion has a protective cover mounted thereon for covering the electrical connector, and the bottom of the protective cover is attached onto the planar portion.

9. The power supply device of a rotary compressor according to claim 8, wherein the planar portion has a fixing element installed thereon for fixing the protective cover.

10. The power supply device of a rotary compressor according to claim 9, wherein the fixing element is a screw rod for fixing the protective cover, and the protective cover has a through hole relative to the screw rod.

11. The power supply device of a rotary compressor according to claim 10, further comprising a gasket installed between the planar portion and the protective cover, and the gasket has an opening relative to the screw rod.

12. The power supply device of a rotary compressor according to claim 11, wherein the gasket has an opening disposed at a position opposite to the electrical connector for exposing the electrical connector.

13. A power supply device of a rotary compressor comprising an electrical connector installed at a casing of the rotary compressor for electrically coupling a motor installed inside the casing and an external power supply, characterized in that the casing has a planar portion disposed on a lateral side of the casing for installing the electrical connector, and the electrical connector has at least three terminals, and is further connected to a connecting element, and the other end of the connecting element is coupled to a protector, and the protector is installed on a lateral side of the casing lateral side and relative to the planar portion at the top of the electrical connector.

14. The power supply device of a rotary compressor according to claim 13, wherein the planar portion has a protective cover mounted thereon for covering the electrical connector, and the bottom of the protective cover is attached onto the planar portion.

15. The power supply device of a rotary compressor according to claim 14, wherein the planar portion has a fixing element installed thereon for fixing the protective cover.

16. The power supply device of a rotary compressor according to claim 15, wherein the fixing element is a screw rod for fixing the protective cover, and the protective cover has a through hole relative to the screw rod.

17. The power supply device of a rotary compressor according to claim 16, further comprising a gasket installed between the planar portion and the protective cover, and the gasket has an opening relative to the screw rod.

18. The power supply device of a rotary compressor according to claim 17, wherein the gasket has an opening relative to the electrical connector for exposing the electrical connector.
